(19) United States
(12) Patent Application Publication
(10) Pub. No.: US 2004/0091665 A1
(43) Pub. Date: May 13, 2004

(54) Device for the arrangement of decorative loops

(75) Inventor: Fernando A. Suzigan, Americana (BR)

Correspondence Address: Ronald Abramson, Hughes Hubbard & Reed LLP, One Battery Park Plaza, New York, NY, 10004-1482, US

(73) Assignee: Progresso Hudtelfa Ltda., Nova Odessa (BR)

(21) Appl. No.: 10/300,658

(22) Filed: Nov. 20, 2002

Related U.S. Application Data
(60) Provisional application No. 60/424,461, filed on Nov. 7, 2002.

(51) Int. Cl. B32B 3/10

(52) U.S. Cl. 428/131

(57) ABSTRACT

A device for the arrangement of decorative loops, comprising a board or wooden base (1), provided with various non-surpassing punctures (2), and designated to set the direction toggles (3) around which the work will be performed with a number of different ribbons to produce a variety of decorative and ornamental loops.

This application claims benefit of U.S. provisional patent application serial No. 60/424,461, filed on Nov. 6, 2002.

### BACKGROUND OF THE INVENTON

The present invention relates to the field of facilitating the handwork from any skillful person to produce loops of ribbons. Other known and available parts from only some countries of Europe or North America, simply do a little piece of work compared to what the current device is capable to do. In contrast to the parts recognized along the distant countries, which producing only few sorts of loops with just one type of fabric, the device consisting of this patent permits to easily construct, even for unable and beginner persons, several types of loops with different kinds of makings.

### SUMMARY OF THE INVENTION

The invention comprises a device for the arrangement of decorative loops made of a wooden board and several toggles that, placed adequately through the planned punctures on the mentioned plate, allows the manufacturing of all variety of loops, which is considered a complete and new development for craftsmen, decorators, gifts packers and all those making use of any kind of ribbons to give finishing to its manual or industrial work, and providing a range of inherent advantages to its applicability.

Its great improvement is in facilitating the handwork from any skillful person to produce loops of ribbons, standardizing and giving speed to the work, as well as creating access to the people who have ever wanted to develop a varied of handworks with ribbons and could never do it, due to the lack of manual ability for such thing.

The device in question is simple to use. With the directed location of its toggles on the board, supplied with the planned punctures, it only remains to follow the weaves', cables' and knots' guidelines to manufacture the most diverse patterns of loops.

The present device brings to the worker or customer the self-realization in their handworks with loops and the professional opportunities in the areas of workmanship, ornamentations, gifts and others.

### BRIEF DESCRIPTION OF THE DRAWINGS

In order to have a clear visualization of the device for the arrangement of decorative loops in this case, the following illustrative drawings are attached, to which it makes references in order to better understand the following detailed description:

FIG. 1: It represents a perspective view of the board and some of the respective toggles taken separately.

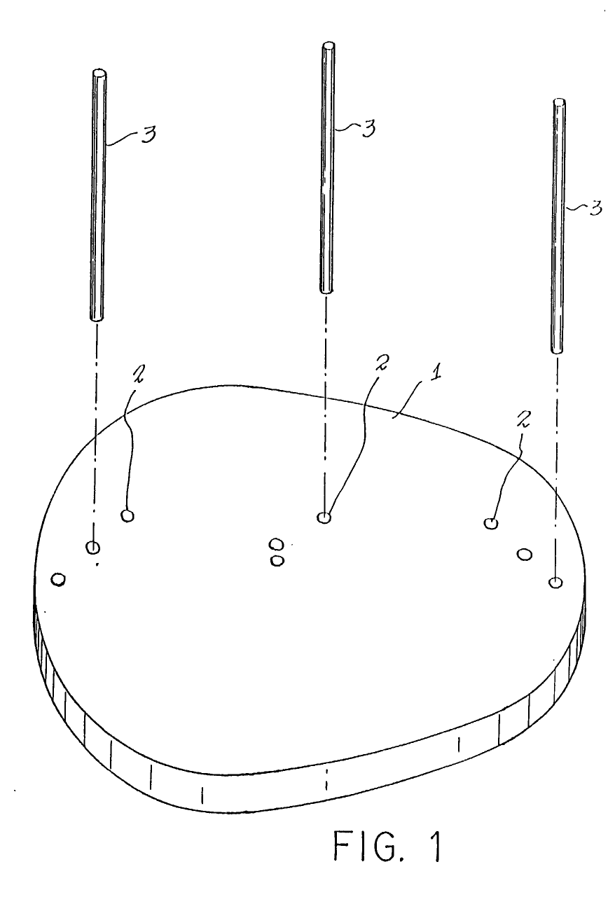

FIG. 2: It represents a perspective view of the board (in a partial segment) with the toggles duly placed on the direction punctures.

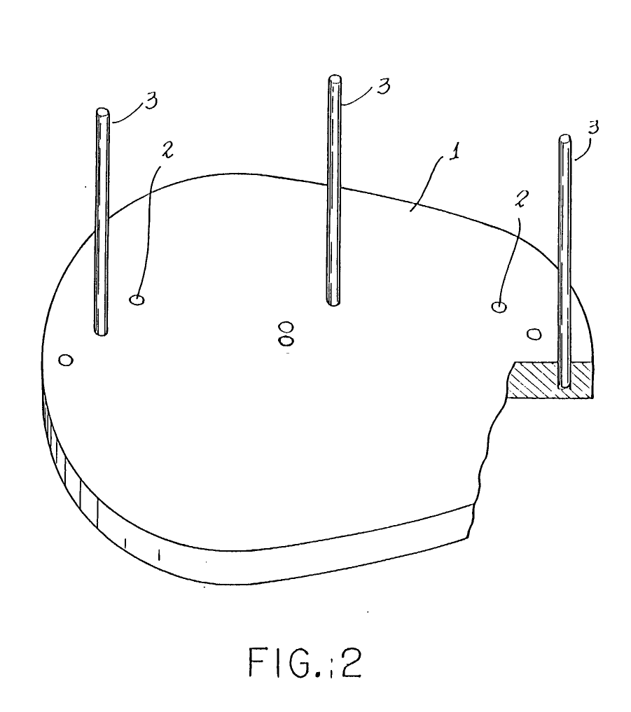

### DETAILED DESCRIPTION OF THE DRAWINGS

In accordance with these illustrations and its details, the device for the arrangement of decorative loops herewith considered is characterized essentially to be composed of a board of wooden base (1), with any shape, in whose surface is made of various projected and non-surpassing punctures (2), designated to the coupling of several direction toggles (3) around which the work will be developed with a number of different ribbons to making a variety of loops for the decorative and ornamental purposes, whose results they will be surprised.

All types of loops will be obtained according to the toggles disposal (3) in the respective punctures (2) combined with the accomplished weaves', cables' and knots' guidelines.

In this way, the mentioned device for the arrangement of decorative loops fully satisfies the considered objectives, carrying out practically and efficiently the proposed functions, that is, the production of the most varied kinds of loops with ribbons and providing a scope of related advantages to its usage, which possessing by itself the same owned, innovative and endowed features with the novelty's basic requirements.

I claim:

1. A device for the arrangement of decorative loops, comprising a board or wooden base, with any shape, in whose surface is made of various projected and non-surpassing punctures, designated to the coupling of several direction toggles around which the work will be developed with a number of different ribbons to make a variety of loops.
